(19) United States
(12) Patent Application Publication
(10) Pub. No.: US 2025/0236106 A1
(43) Pub. Date: Jul. 24, 2025

(54) INKJET HEAD MONITORING SYSTEM AND METHOD

(71) Applicants: SAMSUNG ELECTRONICS CO., LTD., Suwon-si (KR); SOONCHUNHYANG UNIVERSITY INDUSTRY ACADEMY COOPERATION FOUNDATION, Asan-si (KR)

(72) Inventors: Ohyun BEAK, Suwon-si (KR); Kyesi KWON, Asan-si (KR); Keon KUK, Suwon-si (KR); Sanghyeon PARK, Asan-si (KR)

(21) Appl. No.: 19/180,156

(22) Filed: Apr. 16, 2025

Related U.S. Application Data
(63) Continuation of application No. PCT/KR2023/016078, filed on Oct. 17, 2023.

(30) Foreign Application Priority Data
Nov. 25, 2022 (KR) 10-2022-0160912
Dec. 23, 2022 (KR) 10-2022-0183114

(51) Int. Cl. B41J 2/045

(52) U.S. Cl. CPC B41J 2/0451; B41J 2/04581

(57) ABSTRACT

An inkjet head monitoring system includes: a head provided with a plurality of nozzles respectively including piezo actuators and switching elements; a driver which applies a specified voltage to the plurality of nozzles; a sensing circuit which obtains a self-sensing signal from the piezo actuators; and at least one processor. The at least one processor may be configured to: output an injection trigger to the driver to apply a voltage to the plurality of nozzles; obtain, through the sensing circuit, the self-sensing signal from the piezo actuators respectively included in the plurality of nozzles on the basis of a specified scanning frequency; extract data corresponding to at least one frequency from the obtained self-sensing signal; and monitor the status of the plurality of nozzles on the basis of the extracted data corresponding to the at least one frequency.

### CROSS-REFERENCE TO RELATED APPLICATIONS

This application is a continuation application, under 35 U.S.C. § 111(a), of International Patent Application No. PCT/KR2023/016078, filed on Oct. 17, 2023, which claims priority to Korean Patent Application No. 10-2022-0160912, filed on Nov. 25, 2022, and Korean Patent Application No. 10-2022-0183114, filed on Dec. 23, 2022, the contents of which in their entirety is herein incorporated by reference.

### BACKGROUND

### 1. Field

The disclosure relates to a system and method for monitoring the jetting state of an inkjet head including a plurality of nozzles.

### 2. Description of the Related Art

Inkjet printing technology finds its applications in a wider range from desktop printers to various industrial purposes. A single path printing system that simultaneously sprays from tens of print heads is desired in recent industrial printing systems to increase productivity using the inkjet printing technology. An inkjet head may often be in a non-jetting state during printing, and it is important to immediately detect an abnormal condition through monitoring.

To this end, an inkjet printing system may use 100,000 or more nozzles, and a technique for quickly monitoring the jetting state of each of 100,000 nozzles (or ejectors) or more is desired.

### SUMMARY

However, conventional vision-based measurement technology in which a spray image of nozzles is obtained during transfer of a nozzle head is not suitable for scanning the entirety of the nozzles during printing, because a monitoring time should be reduced to a substantially short time so that the printing process is not interrupted in order to monitor the jetting state of each nozzle during the printing.

An inkjet head monitoring system in an embodiment of the disclosure may include a head equipped with a plurality of nozzles each respectively including piezo actuators and switching elements, a driver configured to apply a specified voltage to the plurality of nozzles, a sensing circuit configured to obtain a self-sensing signal from the piezo actuators, and at least one processor. The at least one processor may output a jetting trigger to the driver to apply a voltage to the plurality of nozzles. The at least one processor may obtain the self-sensing signal from the piezo actuators respectively included in the plurality of nozzles based on a specified scanning frequency through the sensing circuit. The at least one processor may extract data corresponding to at least one frequency through the obtained self-sensing signal. The at least one processor may monitor a state of the plurality of nozzles, based on the extracted data corresponding to the at least one frequency.

A method of monitoring an inkjet head in an embodiment of the disclosure may include outputting a jetting trigger to a driver configured to apply a specified voltage to each of a plurality of nozzles respectively including piezo actuators and switching elements. The method of monitoring an inkjet head in an embodiment of the disclosure may include obtaining a self-sensing signal from the piezo actuators included in the plurality of nozzles based on a specified scanning frequency through a sensing circuit. The method of monitoring an inkjet head in an embodiment of the disclosure may include extracting data corresponding to at least one frequency through the obtained self-sensing signal. The method of monitoring an inkjet head in an embodiment of the disclosure may include monitoring a state of the plurality of nozzles, based on the extracted data corresponding to the at least one frequency.

A non-transitory computer-readable storage medium storing at least one program in an embodiment of the disclosure may include, based on execution of an application, outputting a jetting trigger to a driver configured to apply a specified voltage to each of a plurality of nozzles respectively including piezo actuators and switching elements. The storage medium in an embodiment may include monitoring an inkjet head in an embodiment of the disclosure may include obtaining a self-sensing signal from the piezo actuators included in the plurality of nozzles based on a specified scanning frequency through a sensing circuit. The storage medium in an embodiment may include extracting data corresponding to at least one frequency through the obtained self-sensing signal. The storage medium in an embodiment may include monitoring a state of the plurality of nozzles, based on the extracted data corresponding to the at least one frequency.

An inkjet head monitoring system in an embodiment of the disclosure may include a head equipped with a plurality of nozzles each including a piezo actuator and a switching element, a driver configured to apply a specified voltage to the plurality of nozzles, a sensing circuit configured to obtain a self-sensing signal from the piezo actuators, and at least one processor. The at least one processor may output a jetting trigger to the driver to apply a voltage to the plurality of nozzles. The at least one processor may obtain the self-sensing signal from the piezo actuators included in the plurality of nozzles based on a specified scanning frequency through the sensing circuit. The at least one processor may monitor a state of the plurality of nozzles, based on an amplitude difference or a phase difference between the obtained self-sensing signal and a specified reference signal.

### BRIEF DESCRIPTION OF DRAWINGS

The above and other embodiments, advantages and features of this disclosure will become more apparent by describing in further detail embodiments thereof with reference to the accompanying drawings.

FIG. 1 is a block diagram illustrating an embodiment of an inkjet head monitoring system according to the disclosure.

FIG. 2 illustrates a layout of an embodiment of nozzles included in a head according to the disclosure.

FIG. 3 illustrates an embodiment of a jetting trigger signal in a parallel scanning method according to the disclosure.

FIG. 4A illustrates an embodiment of a process of obtaining a self-sensing signal including driving noise according to the disclosure.

FIG. 4B illustrates an embodiment of a process of obtaining driving noise according to the disclosure.

FIG. 5A is a graph illustrating an embodiment of a self-sensing signal including driving noise according to the disclosure.

FIG. 5B is a graph illustrating an embodiment of a self-sensing signal with driving noise cancelled therefrom according to the disclosure.

FIG. 6A illustrates an embodiment of results of analyzing the center frequency of a self-sensing signal of a normal nozzle according to the disclosure.

FIG. 6B illustrates an embodiment of results of analyzing the center frequency of a self-sensing signal of an abnormal nozzle according to the disclosure.

FIG. 7 illustrates an embodiment of software and hardware for vision analysis according to the disclosure.

FIG. 8 illustrates an embodiment of results of vision analysis for various jetting states according to the disclosure.

FIG. 9 is a scatter plot illustrating an embodiment of the differences in amplitude and phase between the self-sensing signals of entire nozzles and reference signals according to the disclosure.

FIG. 10 is a scatter plot illustrating an embodiment of the differences in amplitude and phase between the self-sensing signal of each nozzle and a reference signal according to the disclosure.

FIG. 11A is a scatter plot illustrating an embodiment of the differences in amplitude and phase between a self-sensing signal before noise cancellation and a reference signal according to the disclosure.

FIG. 11B is a scatter plot illustrating an embodiment of the differences in amplitude and phase between a self-sensing signal with driving noise cancelled therefrom and a reference signal according to the disclosure.

FIG. 11C is a scatter plot illustrating an embodiment of the differences between the amplitudes and phases of a self-sensing signal and a reference signal, which correspond to the center frequency of the self-sensing signal according to the disclosure.

FIG. 12 is a flowchart illustrating an embodiment of a method of monitoring an inkjet head according to the disclosure.

### DETAILED DESCRIPTION

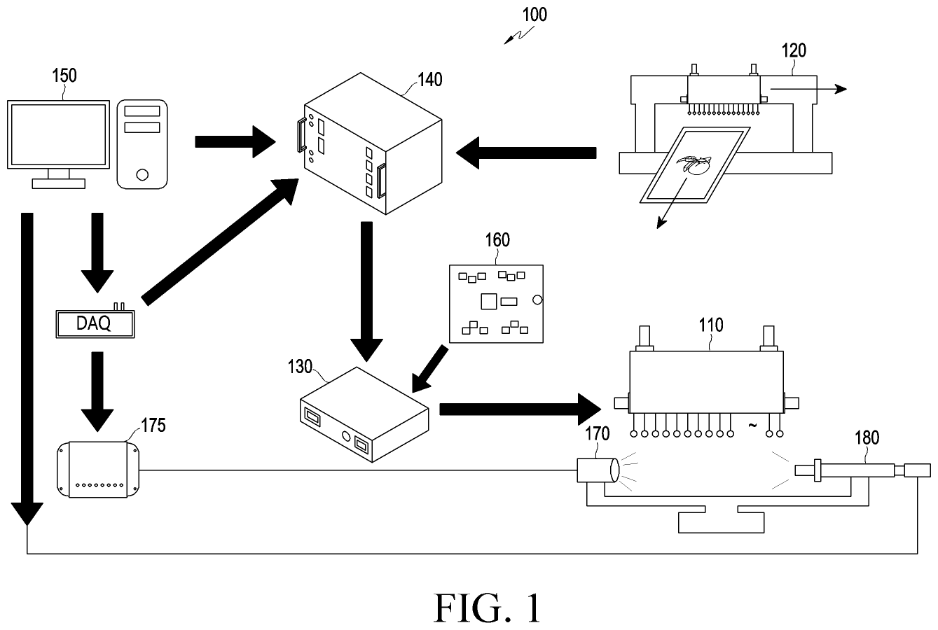

FIG. 1 is a block diagram illustrating an embodiment of an inkjet head monitoring system 100 according to the disclosure.

The inkjet head monitoring system 100 in an embodiment may be applied to an inkjet printing system (e.g., an inkjet printer) using a piezo actuator. In a method of monitoring a nozzle using a piezo actuator, the behavior of a pressure wave in an inkjet head (also referred to as a head) 110 may be indirectly measured from the amount of deformation of the piezo actuator during ink ejection, and it may be identified whether the nozzle is defective from a change in the behavior of the pressure wave, because when the operation state of the nozzle changes from a normal state to an abnormal state, the behavior of the pressure wave of ink changes. In an embodiment, the inkjet head 110 may be a piezo inkjet head that spray ink droplets

from a nozzle by a pressure wave generated when a voltage is applied, using a piezo actuator. That is, the inkjet head 110 may be a piezo inkjet head that obtains a deformation amount by driving the piezo actuator with the voltage. This pressure wave may last for a predetermined period of time (e.g., 70 microseconds [μs]) in the form of vibration, without being immediately attenuated.

In an embodiment, the piezo actuator is an element capable of self-sensing by generating a charge, when there is a deformation amount. Therefore, the deformation amount of the piezo actuator may be calculated by measuring a current flowing through the piezo actuator. That is, the piezo actuator may be used as a sensor by detecting a force resulting from the pressure wave of ink inside an ink dispenser of the inkjet printing system.

In an embodiment, a method of using a piezo self-sensing signal uses an electric signal of the inkjet head 110 without the need for any mechanical fixing device or hardware, thereby simplifying hardware requirements and obviating the need for position control of a camera 180 or a sensor for measuring ink droplets (liquid droplets) sprayed according to transfer of a predetermined nozzle.

In an embodiment, the inkjet printing system may use 50 or more heads 110 each having 1024 nozzles, for use in a display or a printer. That is, 50,000 or more nozzles may perform a printing operation by spraying with relatively high frequency. In an embodiment, the inkjet head monitoring system 100 may monitor the states of nozzles by scanning self-sensing signals of a plurality of nozzles. Scanning may refer to a series of processes of monitoring whether the nozzles are abnormal by sequentially spraying from all nozzles from beginning to end and analyzing self-sensing signals accordingly.

Referring to FIG. 1, the inkjet head monitoring system 100 in an embodiment may include the head 110 having a plurality of nozzles, a driver 130 applying a specified voltage to each of the plurality of nozzles included in the head 110, a sensing circuit 160 measuring a current of a piezo actuator, and/or at least one processor 140.

In an embodiment, the inkjet head monitoring system 100 may include a plurality of heads 110, and also a plurality of drivers 130. In an embodiment, each of the plurality of drivers 130 may be connected to the at least one processor 140.

In an embodiment, the head 110 may be coupled to a motion stage 120 that generates a motion linearly (along the X axis and the Y axis). In an embodiment, the motion stage 120 may include an encoder (e.g., with a resolution of 1 [μm]) that detects movement in each linear direction.

In an embodiment, the head 110 may be provided with a plurality of nozzles in parallel, and each nozzle may include a piezo actuator and a switching element. In an embodiment, the head 110 may include, as a piezo inkjet head 110, two or more multi-heads 110 as well as a single head 110 with a plurality of nozzles (e.g., 1024 or more nozzles) formed therein, for example. Hereinafter, “multiple nozzles” may mean 1024 or more nozzles formed in the two or more multi-heads 110 as well as 1024 or more nozzles formed in the single head 110. In order to help understanding, a case in which 1024 nozzles are formed in the head 110 will be described as an example.

In an embodiment, a nozzle may include a piezo actuator and a switching element. In an embodiment, the switching element may control turn-on or turn-off of the nozzle based on a voltage input from the driver 130.

In an embodiment, the driver 130 may be provided with an output resistor RO to adjust output impedance, and supply a driving voltage to the head 110 connected in series through the output resistor R0.

In an embodiment, the sensing circuit 160 is a part that obtains the current of a piezo actuator for each nozzle from the head 110 and processes it, and may be provided in the form of electronic sensing circuits or a sensing module. In an embodiment, the sensing circuit 160 may be integrated into the driver 130 in the form of a module. When the sensing circuit 160 is formed integrally with the driver 130, it may have a zero form factor for a monitoring module applicable to most inkjet applications.

Hereinafter, a “self-sensing signal” may mean a current signal of a piezo actuator extracted from the head 110.

In an embodiment, the sensing circuit 160 may obtain a current difference signal by subtracting a current output from the piezo actuator of each of the nozzles in a neighboring (adjacent) predetermined nozzle row by sequentially turning on the switching elements of the nozzles in the neighboring (adjacent) nozzle row based on the driving voltage of the driver 130 from a current output from the piezo actuator of each of the nozzles in a predetermined nozzle row by sequentially turning on the switching elements of the nozzles in the predetermined nozzle row based on the driving voltage of the driver 130.

In an embodiment, the processor 140 may control at least one other component (e.g., a hardware or software component) connected to the processor 140 by executing software (e.g., a program), and perform various data processes or operations. In an embodiment, as at least a part of a data process or operation, the processor 140 may store a command or data received from another component (e.g., a sensor module or a communication module) in volatile memory, process a command or data stored in the volatile memory, and store resulting data in non-volatile memory.

In an embodiment, the processor 140 may apply a driving voltage from the driver 130 to the head 110, and obtain or analyze a self-sensing signal in conjunction with the sensing circuit 160 described below.

In an embodiment, a self-sensing signal obtained from the sensing circuit 160 may be processed or determined by the processor 140, and information about the state of a nozzle according to the signal may be transmitted to an external device 150 (e.g., a personal computer (“PC”) or an external data storage device).

In an embodiment, the monitoring system 100 may further include a strobe LED 170 and the camera 180 for vision analysis in which a jetting speed and jetting directionality are measured using a water droplet jetting image. The strobe LED 170 may be controlled by a trigger from the external device 150 and driven by an LED driver 175. The monitoring system 100 may further use vision analysis to verify a nozzle monitoring result.

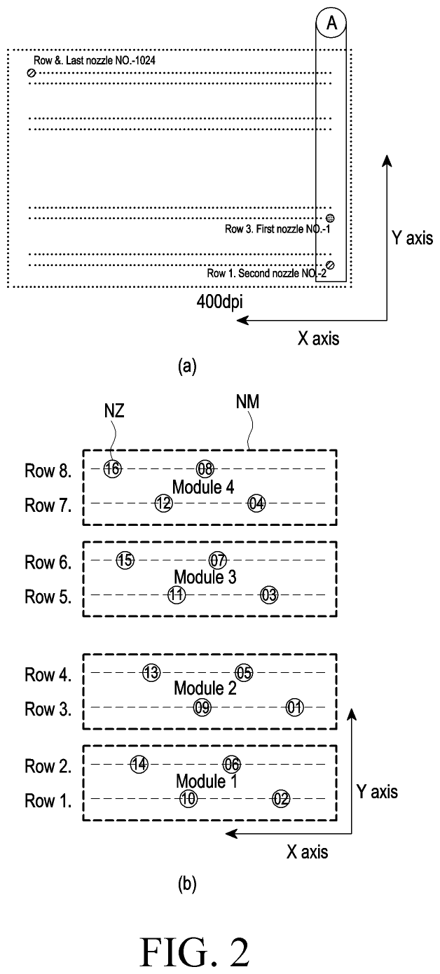

FIG. 2 illustrates an embodiment of a layout of nozzles included in the head 110 according to the disclosure.

Referring to FIG. 2, a plurality of nozzles NZ may be arranged in a plurality of nozzle rows in the head 110. In an embodiment, as illustrated in (a) of FIG. 2, 1024 nozzles NZ of the head 110 are provided in 8 nozzle rows each having 128 nozzles arranged therein, for example. 128 nozzles are arranged on the same line to form one nozzle row, and the 1024 nozzles may be formed in the 8 nozzle rows in the head 110.

The predetermined layout of the nozzles may vary depending on the head 110. However, a plurality of nozzle rows are generally formed in a head 110 having a relatively large number of nozzles, and the driver 130 may independently apply a voltage to drive each nozzle row or a plurality of nozzles.

In an embodiment, each nozzle in one nozzle row may be spaced apart from neighboring (adjacent) nozzles by a predetermined gap. In an embodiment, when the gap between nozzles in the same nozzle row is 50 dpi, a resolution in a printing direction may be 400 dpi through fine adjustment of a nozzle-direction gap between nozzle rows, for example.

In an embodiment, the plurality of nozzles NZ may be divided into a plurality of electrically independent nozzle modules each including a plurality of nozzle rows or nozzle groups. In an embodiment, (b) of FIG. 2 is an enlarged view of a part “A” in (a) of FIG. 2, and the numbers of nozzles belonging to the part “A” are indicated. In an embodiment, in the case of (b) of FIG. 2, although nozzles labeled with numbers 01 and 02 have a distance (gap) of 0.0635 mm in the X-axis direction, they may not be in the same nozzle row, for example. In an embodiment, neighboring (adjacent) nozzles in a nozzle row may have a number difference of 8 and the distance between them may be 0.0635×8=0.508 mm.

In an embodiment, the nozzles in the same nozzle row may share the same driving voltage from a single driver 130, and 8 independent driving voltages (i.e., 8 drivers 130) may be used to drive or spray from 1024 nozzles. Because of the advantage of reducing the cost of the drivers 130, shared drivers 130 may be used to drive many nozzles (e.g., 128 nozzles per driver 130) (shared drive method). In this case, the drivers 130 may drive or spray from the nozzle rows or nozzle modules by applying a plurality of independent driving voltages. Herein, a system (e.g., the inkjet head monitoring system 100) and method for monitoring a head 110 having 1024 nozzles in 8 nozzle rows will be described, and the layout of the head 110 including the predetermined numbers of nozzles and nozzle rows is not limited to the illustrated form.

Referring to (b) of FIG. 2, one nozzle module NM may include two neighboring (adjacent) nozzle rows, and one head 110 or 111 may include four nozzle modules NM.

In an embodiment, the processor 140 may apply a jetting trigger to the nozzles of the drivers 130 so that for each nozzle module NM or for each driver 130 that generates an independent voltage, one nozzle is repeatedly and simultaneously made to spray. Further, as many sensing circuits 160 as the number of nozzle modules NM or the number of drivers 130 that generate independent voltages may be provided. Each data collector for storing a self-sensing signal obtained by each sensing circuit 160 may be provided.

In an embodiment, the monitoring system (e.g., the inkjet head monitoring system 100 of FIG. 1) may use four sensing circuits 160 and four memories to monitor four nozzle modules NM having 1024 nozzles, for example. The data collectors may also be provided in the form of data collection channels or DAQs.

In the monitoring system (e.g., 100 in FIG. 1) in an embodiment may use a parallel scanning method to quickly scan the entirety of the nozzles regardless of the numbers of nozzles, nozzle modules, and heads 110.

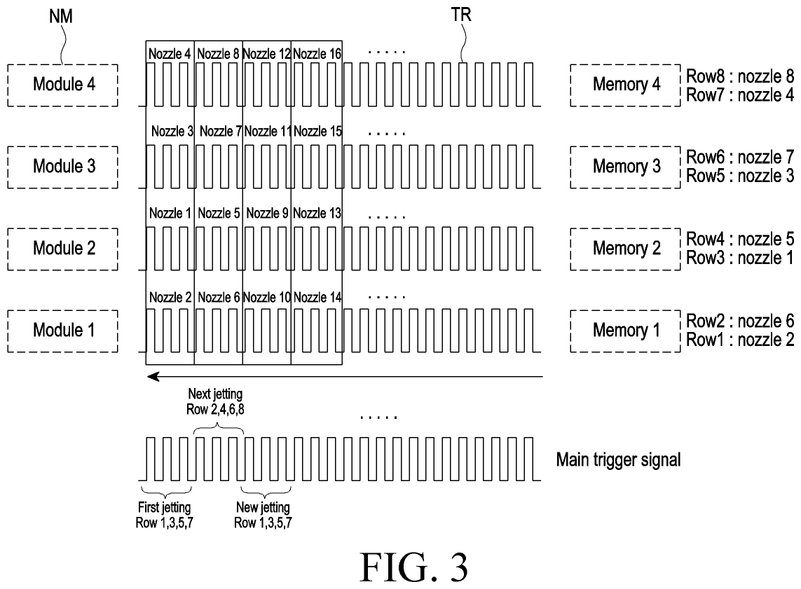

FIG. 3 illustrates an embodiment of a jetting trigger signal in a parallel scanning method according to the disclosure.

Referring to FIG. 3, a plurality of jetting triggers TR may be repeatedly or sequentially applied to a nozzle NZ to repeatedly spray from the nozzle NZ, and the number of jetting triggers TR applied to each simultaneously spraying nozzle NZ may be the same.

In an embodiment, a multiple times averaging method (e.g., 3 times averaging, Nₐᵥₑ=3) may be used for each nozzle NZ. However, the number of times the jetting trigger signal TR is repeatedly applied for averaging is not limited to 3.

In an embodiment, the sensing circuit 160 may obtain repeated self-sensing signals for each nozzle, for averaging the self-sensing signals, and to this end, repeatedly sprays from each nozzle. Each jetting trigger may be used for a data collection trigger.

In an embodiment, the sensing circuit 160 may obtain a self-sensing signal from a nozzle, wherein it may obtain as many repeated self-sensing signals as the number of a plurality of jetting triggers for each nozzle and calculate the average value of the self-sensing signals.

In an embodiment, the processor 140 may control to spray from one nozzle or generate a pressure wave for one nozzle per nozzle module NM in order to monitor a predetermined nozzle, while controlling not to spray remaining (the other) nozzles. Otherwise, signals of remaining (the other) nozzles (i.e., nozzles to which the jetting trigger is not applied) may appear in self-sensing signals, and the resulting mixed signals may make it impossible to detect the jetting state of the predetermined nozzle.

The monitoring system (e.g., the inkjet head monitoring system 100) in an embodiment may simultaneously spray from up to four nozzles NZ, for scanning the nozzles. FIG. 3 relates to a spray scanning scenario in which one nozzle sprays in each of the nozzle modules, Module 1 to Module 4, for simultaneously spraying from a total of four nozzles, thereby minimizing the scanning time of the entirety of the nozzles.

In an embodiment, the monitoring system (e.g., the inkjet monitoring system 100) may repeatedly apply a jetting trigger signal TR for scanning to each nozzle, apply the jetting trigger signal TR as many times as a specified averaging number or more to each nozzle, and average sensing signals obtained accordingly. The scanning time may be shortened by a parallel measurement method in which the jetting trigger signal TR is simultaneously applied to each independent module and/or circuit.

In an embodiment, in order to average self-sensing signals, three jetting triggers TR are applied to one nozzle per nozzle module at a predetermined frequency, and four nozzles 1, 2, 3, and 4 may spray simultaneously by three jetting triggers applied initially, for example. At this time, the remaining nozzles except for nozzles 1, 2, 3, and 4 may be turned off so as not to spray. Nozzles 1, 2, 3, and 4 may be included in different nozzle modules and have circuits independent of each other. Nozzle 1, nozzle 2, nozzle 3, and nozzle 4 may spray simultaneously in nozzle module 1, nozzle module 2, nozzle module 3, and nozzle module 4, respectively.

In an embodiment, three jetting triggers are applied simultaneously to nozzles 1, 2, 3, and 4. Since nozzles 1, 2, 3, and 4 should spray simultaneously, first, second, and third triggers may be applied to nozzles 1, 2, 3, and 4 at the same timings. This simultaneous parallel jetting is for parallel sensing to minimize a detection time. In an embodiment, simultaneous scanning may also be performed for two or more multi-heads 110 by jetting triggers for all heads 110, thereby minimizing a detection time.

In an embodiment, nozzles 2, 6, 10, 14, and so on may be arranged in a row in nozzle module 1, nozzles 1, 5, 9, 13, and so on may be arranged in a row in nozzle module 2, nozzles 3, 7, 11, 15, and so on may be arranged in a row in nozzle module 3, and nozzles 4, 8, 12, 16, and so on may be arranged in a row in nozzle module 4. After nozzles 1, 2, 3, and 4 simultaneously spray, the next nozzle in each nozzle module, that is, nozzles 5, 6, 7, and 8 may simultaneously spray. Three jetting triggers may also be sequentially or repeatedly applied to nozzles 5, 6, 7, and 8.

Accordingly, the parallel spraying method in which scanning is performed through simultaneous spraying from one nozzle in each module and simultaneous spraying from the next nozzle in each module may enable a relatively large number of nozzles to be monitored in a short period of time. Herein, ink may not be sprayed from the actual nozzles, and the behavior of a pressure wave for monitoring sensing needs to be measured, so that a weak voltage may be applied not to actually spray ink, thereby preventing unnecessary spraying while enabling nozzle monitoring.

In an embodiment, the processor 140 may repeatedly or sequentially apply the same number of jetting triggers to one nozzle disposed next (i.e., next to a nozzle which has sprayed) in each nozzle module, after a plurality of jetting triggers TR are applied to the nozzle (the nozzle refers to one to which the jetting triggers are applied and thus which sprays).

In an embodiment, the processor 140 may control the remaining nozzles in the nozzle module or nozzles connected to the drivers 130 of the same electrical voltages not to spray during spraying of the spraying nozzles. In this way, as one nozzle sprays simultaneously and the next nozzle sprays simultaneously in each nozzle module, the total number of jetting triggers applied to the nozzles may be reduced, and the scanning time of the total 1024 nozzles may be equal to the scanning time of 256 nozzles.

Specifically, a scanning time T_{scan} desired for the entirety of the 1024 nozzles in the nozzle modules each including 256 nozzles with independent circuits may be calculated by [Equation 1] below.

$${T}_{scan} = ( {N}_{a v e} \times 2 \; 56 ) / F \qquad [ Equation 1 ]$$

Nₐᵥₑ is a specified averaging number, and F is a scanning frequency. The scanning frequency F is fixed throughout the scanning process, and spraying nozzles may be switched to the next nozzles to scan the entirety of the nozzles according to the parallel scanning scenario during a time interval between jetting triggers. In an embodiment, since a nozzle module with an independent circuit consists of two nozzle rows and may include 256 nozzles, 256 is used in [Equation 1]. The number of nozzles in the nozzle module may be changed, and [Equation 1] may be modified accordingly.

In an embodiment, referring to FIG. 3, after a specified averaging number of (e.g., three) jetting triggers TR are applied to nozzle 2 in nozzle module 1, there is a time interval between the third jetting trigger and the fourth jetting trigger, and the spraying nozzle may be switched from nozzle 2 to nozzle 6 during this time interval, for example. The time interval (gap) may be the reciprocal of an ejection frequency, and thus, switching to another nozzle may be completed in a substantially short period. Therefore, the monitoring system (e.g., the inkjet head monitoring system 100 of FIG. 1) in an embodiment may reduce a time desired for scanning the entirety of the nozzles to about 1 second by the sequential parallel scanning jetting method.

A scenario based on the parallel scanning jetting method in an embodiment may be implemented in all drivers (e.g., printing drivers) 130 by uploading printing data (a bitmap) that generates scanning jetting according to a jetting trigger generated externally or internally to the drivers 130. In this respect, the parallel scanning jetting method according to the disclosure is similar to bitmap printing that prints a predetermined pattern.

The jetting trigger signal for scanning may not be generated from an encoder of the motion stage 120 in the piezo inkjet printing system, but may be generated internally at a set scanning frequency F unlike the printing process.

In an embodiment, although a higher scanning frequency F may be used to quickly scan the entirety of the nozzles, the magnitude of the scanning frequency F may be limited due to data collection requirements. In an embodiment, 100 data samples (N_{data}=100) may be desired per jetting trigger signal (data collection trigger) having a sampling rate of 1 mega samples per second (MS/s). Considering a data collection time, the scanning frequency F may be 10 kilohertz (kHz) or less, for example.

In an embodiment, the processor 140 may set the scanning frequency F for the jetting trigger signal TR or the data collection trigger signal, and change the scanning frequency depending on a time desired to spray from the entirety of the nozzles. The jetting trigger signal TR may be generated internally at the scanning frequency.

In an embodiment, when the scanning frequency is high, a pressure wave generated inside the head 110 may not be completely attenuated until the next jetting trigger signal TR is applied. In an embodiment, when the pressure wave generated from the previous jetting trigger is not completely attenuated, a self-sensing signal may be changed according to the scanning frequency. However, when the scanning frequency is unified in a manner that compares a signal (i.e., a reference signal) under a normal jetting condition with a monitoring signal, this may not affect a monitoring result. In an embodiment, when a scanning frequency of 9 kHz is used, the averaging number Nₐᵥₑ may affect the total scanning time T_{scan} defined in [Equation 1]. When the averaging number Nₐᵥₑ is reduced, the monitoring result may not be accurate due to the presence of electrical noise, for example. Considering the trade-off relationship, an averaging number of 10 to 30 (Nₐᵥₑ=10 to 30) is preferably used. When the averaging number is set to 10, the total scanning time T for scanning 1024 nozzles is 0.28 seconds. During the scanning process, sampled sensing data may be sequentially stored in the data collector (e.g., memory) of each nozzle module.

In an embodiment, the number of sampled data after scanning may be Nₐᵥₑ×1024×N_{data} where Nₐᵥₑ=10 and N_{data}=100. Repeated self-sensing data of each nozzle may be averaged by

Nave in firmware, and the total number of data requiring data transmission to the external device 150 for future analysis may be reduced to 1024×100. In an embodiment, when the communication speed is sufficiently high, the averaging process may be performed after data is received by the external device 150. Since an initial self-sensing signal is easily affected by a driving signal, the first 10 to 40 data out of 100 data N_{data} are not used, and the 60 to 90 data obtained may be used.

In an embodiment, the processor 140 may compare a reference signal Xₖ^{r} of each nozzle measured under a normal jetting condition with a monitoring signal (i.e., a self-sensing signal Xₖ^{m}) to determine a nozzle jetting error (failure) based on the self-sensing signal. The reference signal Xₖ^{r} may represent a nozzle signals under the normal jetting condition. The reference signal may be calculated by averaging self-sensing signals of all nozzles in the same nozzle row. In an embodiment, the monitoring system (e.g., the inkjet head monitoring system 100) may store eight reference signals, since each head 110 may include eight independent drivers 130.

In an embodiment, the processor 140 may use two different methods to determine a nozzle state. That is, the cosine values or variance values of a reference signals and a self-sensing signal may be used.

In an embodiment, the processor 140 may use a cosine value Cₖ between a reference signal Xₖ^{r} (i.e., a base signal) of each nozzle under the normal jetting condition and a self-sensing signal Xₖ^{m} of the nozzle to determine the state of the nozzle from the self-sensing signal. In an embodiment, the cosine value may be expressed as [Equation 2], for example.

$${C}_{k} = \frac{{x}_{k}^{r} \cdot {x}_{k}^{m}}{\vert {x}_{k}^{r} \vert \vert {x}_{k}^{m} \vert} \qquad [ Equation 2 ]$$

In [Equation 2], Xₖ^{r} is a reference signal for a nozzle with nozzle number k, and Xₖ^{m} is a self-sensing signal of the nozzle with nozzle number k. Since the reference signal and the self-sensing signal are vectors, the dot · may represent a vector inner product (the dot sum of the two vectors). When there are 1024 nozzles, =1, 2, 3 . . . , 1024.

The average value of all corresponding nozzle signals in the driver 130 may be used as the reference signal for corresponding nozzles. Herein, a value when at least 70% of the nozzles are in the normal jetting condition may be used as the reference signal. In an embodiment, a phase change in the monitoring signal (i.e., self-sensing signal) for

the reference signal Xₖ^{r} may be detected from the cosine value Cₖ of the above [Equation 2]. In an embodiment, when the phase difference between the self-sensing signal and the reference signal Xₖ^{r} is 0 degrees, the cosine value is 1, and when the phase difference increases and approaches 180 degrees, the cosine value may become −1, for example.

In an embodiment, a frequency change of the signal may be detected from the cosine value of [Equation 2]. When the center frequencies of the two compared signals, that is, the reference signal and the self-sensing signal are not the same, the cosine value may become close to 0.

In an embodiment, the cosine value of [Equation 2] may be advantageous in that the cosine value may be easily normalized from −1 to 1 depending on the proximity between the reference signal and the self-sensing signal. In addition, the method using a cosine value may be less affected by electrical noise that is not related to a pressure signal. However, the nozzle jetting error (failure) that affects the amplitude of the signal may not be detected without changing the phase of the signal.

The monitoring system (e.g., the inkjet head monitoring system 100 of FIG. 1) in an embodiment may use a variance value as an additional method. For this purpose, the processor 140 may use a variance value Vₖ expressed as [Equation 3] below to determine the state of a nozzle.

$${v}_{k} = {\sum }_{j = 1}^{N} {[ {x}_{k}^{r} ( j ) - {x}_{k}^{m} ( j ) ]}^{2} \qquad [ Equation 3 ]$$

In [Equation 3], N may represent the number of sampled self-sensing data. In an embodiment, on the assumption that the first 40 data are excluded from 100 sampled data (N_{data}=100), N=60 may be used, for example.

In an embodiment, the use of [Equation 3] may enable effective detection of even a substantially small change in the self-sensing signal. However, the monitoring result may be easily affected by electrical noise. Since the two different methods in [Equation 2] and [Equation 3] have their own advantages, the accuracy of the monitoring result may be improved by combining the two methods.

In an embodiment, a new decision criterion based on [Equation 2] and [Equation 3] may be expressed as [Equation 4] below.

$${D}_{k} = {A}_{1} * {C}_{k} + ( {A}_{2} ) / ( {A}_{3} {V}_{k} + 1 ) \qquad [ Equation 4 ]$$

In [Equation 4], Dₖ is the score of a nozzle, and A₁, A₂, and Aare scale factors. A monitored signal may be scored using [Equation 4] according to its proximity to a reference signal. A nozzle having a score lower than a threshold may be classified as a defective nozzle requiring repair and maintenance by setting a threshold range from 0 to 100. [Equation 4] is an illustrative embodiment for combining two different equations, and the advantages and disadvantages of the two equations, that is, [Equation 2] and [Equation 3] may be used by a different combination method.

In an embodiment, the scale factor of each criterion A1, A2, and A3 should be considered because Vₖ has different characteristics from Cₖ. In an embodiment, a smaller value of Vₖ closer to 0 indicates a normal jetting state, while a larger value of Cₖ closer to 1 indicates a normal jetting state, for example. To make a higher value for a better condition, the inverse function of Vₖ may be considered. Further, to avoid the possibility of division by 0, one constant value 1 may be added. In an embodiment, the scale factor of A₃ is considered to maintain a balance between the constant and VR. Further, the weights of A₁ and A₂ may be considered so that the maximum value of Vₖ may be 100 to easily understand a failure degree.

However, since the two parameters Cₖ and Vₖ have different value ranges and sensitivities, it may be difficult to set an appropriate weighting factor.

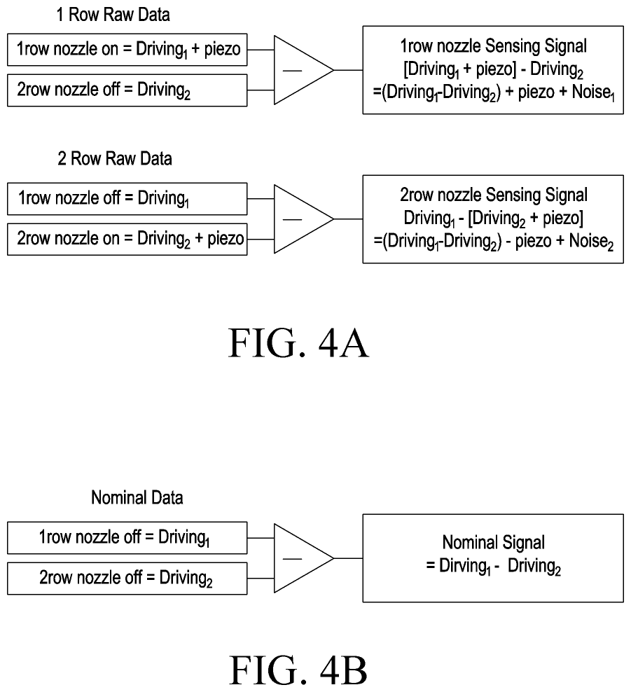

FIG. 4A illustrates an embodiment of a process of obtaining a self-sensing signal including driving noise according to the disclosure. FIG. 4B illustrates an embodiment of a process of obtaining driving noise according to the disclosure.

Referring to FIGS. 4A and 4B, a plurality of nozzles in an embodiment of the disclosure may be divided into a plurality of nozzle rows, and each nozzle row may include a plurality of nozzles. In an embodiment, the plurality of nozzle rows may be divided into at least one nozzle module. In an embodiment, two nozzle rows, 1 row nozzle and 2 row nozzle may be grouped into one nozzle module, for example.

In an embodiment, the sensing circuit 160 may detect a self-sensing signal for one nozzle module. In an embodiment, the sensing circuit 160 may detect a signal difference between a first nozzle row, 1 row nozzle and a second nozzle row, 2 row nozzle included in one nozzle module. Since the first nozzle row and the second nozzle row are not turned on simultaneously but are turned on/off alternately, signals of the piezo actuators included in each of the first nozzle row and the second nozzle row may be detected by one sensing circuit 160.

In an embodiment, the processor 140 may control the nozzles of the plurality of nozzle rows in one nozzle module to be turned on alternately, one by one, and the sensing circuit 160 may detect self-sensing signals in a state where the nozzles included in the nozzle rows are sequentially turned on.

In an embodiment, 1 Row Raw Data may be a self-sensing signal in a state where the first nozzle row, 1 row nozzle is turned on and the second nozzle row, 2 row nozzle is turned off. 1 Row Raw Data may be a value obtained by subtracting a driving signal Driving₂ of the second nozzle row from the sum of a driving signal Driving₁ and a piezo signal of the first nozzle row, for example. In an embodiment, 2 Row Raw Data may be a self-sensing signal in a state where the second nozzle row, 2 row nozzle is turned on and the first nozzle row, 1 row nozzle is turned off. 2 Row Raw Data may be a value obtained by subtracting the sum of the driving signal Driving₂ and the piezo signal of the second nozzle row from the driving signal Driving₁ of the first nozzle row, for example.

Therefore, both 1 Row Raw Data and 2 Row Raw Data may include the difference between the driving signal Driving₁ of the first nozzle row and the driving signal Driving₂ of the second nozzle row as driving noise, Nominal Data.

In an embodiment, the processor 140 may cancel the driving noise, Nominal Data from raw data of the obtained self-sensing signal. In an embodiment, when the driving voltage of the driver 130 which is a relatively high voltage is applied, a transient signal may be maintained due to the influence of a slew rate.

In an embodiment, the processor 140 may obtain driving noise through the sensing circuit 160, while all of the plurality of nozzles are turned off with the driving voltage applied to the plurality of nozzles (nozzle rows). The driving noise may be the difference between the driving signal Driving₁ of the first nozzle row and the driving signal Driving₂ of the second nozzle row.

In an embodiment, the processor 140 may obtain driving noise Nominal Data for each driver 130 or each nozzle row and store it in the memory. In an embodiment, in order to minimize the influence of noise existing in the driving noise Nominal Data, the processor 140 may obtain an average value of the driving noise Nominal Data obtained for each nozzle included in each nozzle row. The driving noise Nominal Data is a signal noise resulting from applying a voltage of the driver 130, and since it is a drift signal that does not change randomly and is repeatedly generated by the application of the driving voltage, it may be removed.

In an embodiment, the processor 140 may cancel driving noise Nominal Data from a specified reference signal.

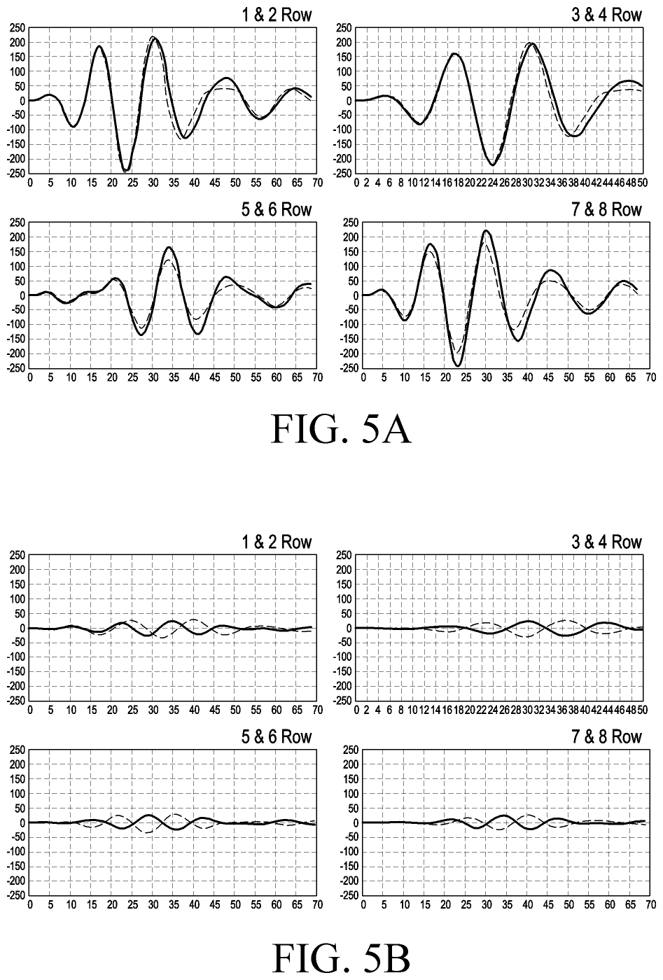

FIG. 5A is a graph illustrating an embodiment of a self-sensing signal including driving noise according to the disclosure. FIG. 5B is a graph illustrating an embodiment of a self-sensing signal from which driving noise has been cancelled according to the disclosure.

Referring to FIGS. 5A and 5B, it may be identified that the driving noise significantly affects the raw data of a self-sensing signal.

As illustrated in FIG. 5B, when the driving noise is canceled, it may be identified that each of piezo signals in a neighboring (adjacent) nozzle row included in a nozzle module appears as a positive or negative number. Therefore, after the driving noise is canceled, it becomes easy to measure a change in the phase of data, thereby improving monitoring performance.

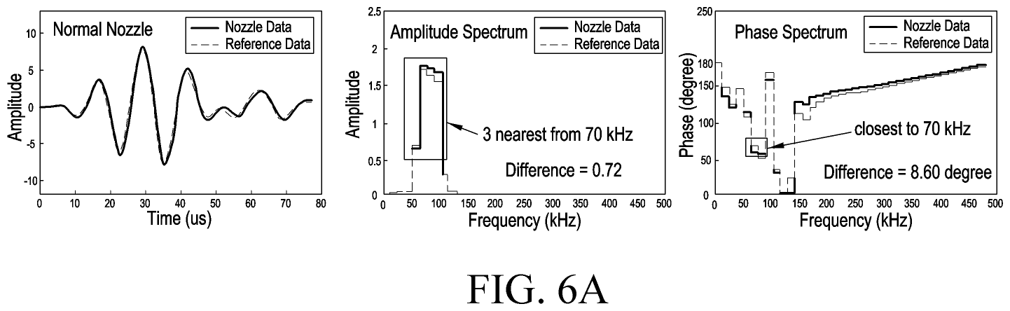

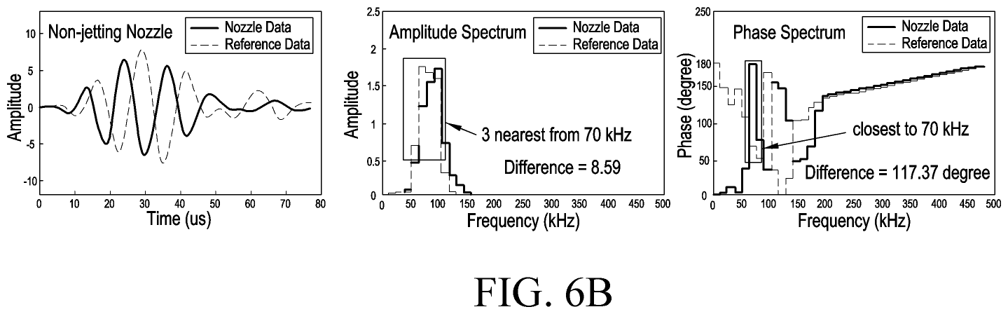

FIG. 6A illustrates the result of analyzing the center frequency of a self-sensing signal from a normal nozzle according to the disclosure. FIG. 6B illustrates the result of analyzing the center frequency of a self-sensing signal from an abnormal nozzle according to the disclosure.

Referring to FIGS. 6A and 6B, the processor 140 in an embodiment may extract data corresponding to at least one frequency from an obtained self-sensing signal.

In an embodiment, the processor 140 may extract the amplitude and phase of the obtained self-sensing signal according to the frequency based on discrete fast Fourier transform (FFT) analysis.

In an embodiment, when a sampling frequency and the number of data to be used are determined, the resolution of the frequency may be determined. In general, the sampling frequency is substantially high and the number of data is small, and thus the frequency resolution is relatively large. Since the frequency resolution df is f/N (where f is the sampling frequency, and N is the number of data), e.g., when the sampling frequency is 1 MS/s and N=70, the frequency resolution may be approximately 14 [KHz].

In an embodiment, when the center frequency (e.g., a frequency with a maximum magnitude according to the frequency analysis result) of the self-sensing signal is around 70 [KHz], amplitude changes corresponding to a plurality of (e.g., 3) frequencies adjacent to the center frequency of the self-sensing signal may be used in consideration of a frequency shift caused by frequency leakage and frequency defects. Accordingly, the influence on frequency components other than the center frequency (e.g., a plurality of adjacent frequencies) of the self-sensing signal may be removed.

In an embodiment, the processor 140 may extract amplitudes of the self-sensing signal corresponding to a plurality of frequencies including the center frequency of the self-sensing signal. In an embodiment, when the center frequency of the self-sensing signal is 70 [kHz], an adjacent frequency may be 56 [KHz] or 84 [kHz] in consideration of the resolution, for example. In an embodiment, the processor 140 may extract the amplitudes of the self-sensing signal corresponding to the center frequency 70 [KHz] and the adjacent frequencies 56 [kHz] and 84 [KHz] of the self-sensing signal, for example. In an embodiment, the processor 140 may obtain an amplitude difference between a self-sensing signal extracted at each frequency and a specified reference signal.

In an embodiment, the processor 140 may normalize the difference between the amplitude of the self-sensing signal corresponding to at least one frequency and the magnitude of the specified reference signal corresponding to the at least one frequency by dividing the difference by the amount of variation (standard deviation) of noise. Since the sensing time is substantially short, the state of a nozzle may hardly change, and thus the signal may change due to randomly occurring noise. Therefore, a relative amplitude comparison may be possible by comparing a self-sensing signal collected for each nozzle at each time with the amount of variation (standard deviation) of the noise.

In an embodiment, the processor 140 may divide amplitude differences of the self-sensing signal corresponding to three frequencies by three times the amount of variation (standard deviation) of the noise, as in [Equation 5] below. The value calculated by [Equation 5] may be referred to as a signal-to-noise (SN) ratio.

$$Δ A = \frac{Δσ ( f - Δ f ) + Δσ ( f ) + Δσ ( f + Δ f )}{3 σ} \qquad [ Equation 5 ]$$

In [Equation 5], Δσ may be a function of the difference in amplitude between a self-sensing signal and a reference signal at a predetermined frequency. f is the center frequency of the self-sensing signal, and Δf may be the resolution of the frequency. σ may be the amount of variation (standard deviation) of the noise.

In an embodiment, when the normalized SN ratio is 1 or larger, the processor 140 may determine the corresponding nozzle as defective, since it is a value that has changed sufficiently, compared to the noise. In general, when nozzles with SN ratios of about 0.3 to 0.4 or larger are classified, even a nozzle with a reduced speed or a wetting phenomenon may be detected.

As illustrated in FIG. 6A, when a nozzle is normal, the ratio (the value of [Equation 5]) between an amplitude difference at the center frequency and its adjacent frequencies and noise is 0.72, which is a substantially relatively small level. However, as illustrated in FIG. 6B, when the nozzle is abnormal, the ratio (the value of [Equation 5]) between an amplitude difference at the center frequency and its adjacent frequencies and noise may increase relatively significantly to 8.59.

In an embodiment, the processor 140 may extract a phase of the self-sensing signal corresponding to the center frequency of the self-sensing signal. The processor 140 may extract the difference between the extracted phase of the self-sensing signal corresponding to the center frequency of the self-sensing signal and a phase of the specified reference signal corresponding to the center frequency of the self-sensing signal, as in [Equation 6].

$$Δφ = {φ}_{r} ( f ) - {φ}_{s} ( f ) \qquad [ Equation 6 ]$$

In [Equation 6], f may be the center frequency of the self-sensing signal, Or may be the reference signal at a predetermined frequency, and Ys may be the self-sensing signal at the predetermined frequency.

As illustrated in FIG. 6A, when the nozzle is normal, the phase difference at the center frequency is 8.60 [degree], which is substantially small. However, as illustrated in FIG. 6B, when the nozzle is abnormal, the phase difference at the center frequency may increase relatively significantly to 117.37 [degree].

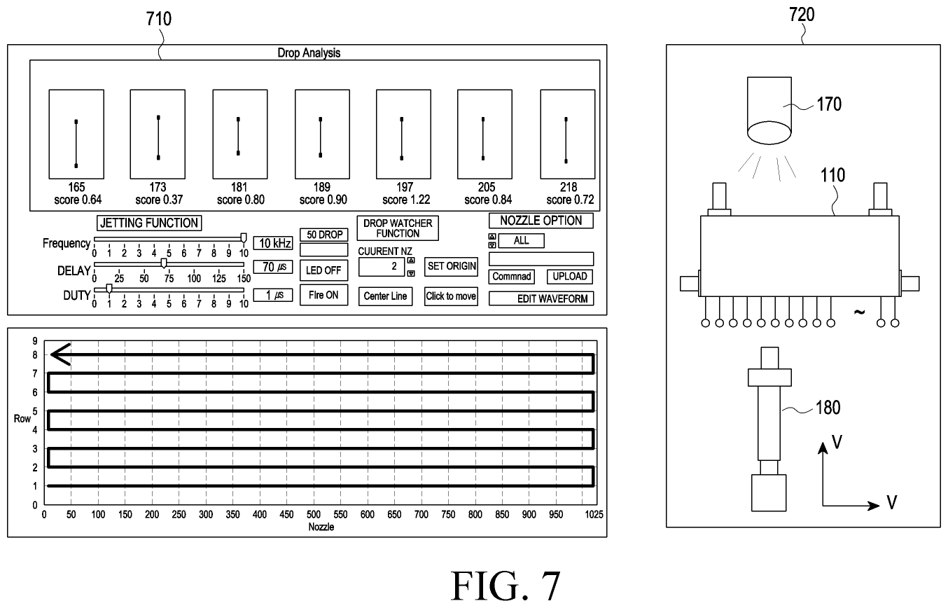

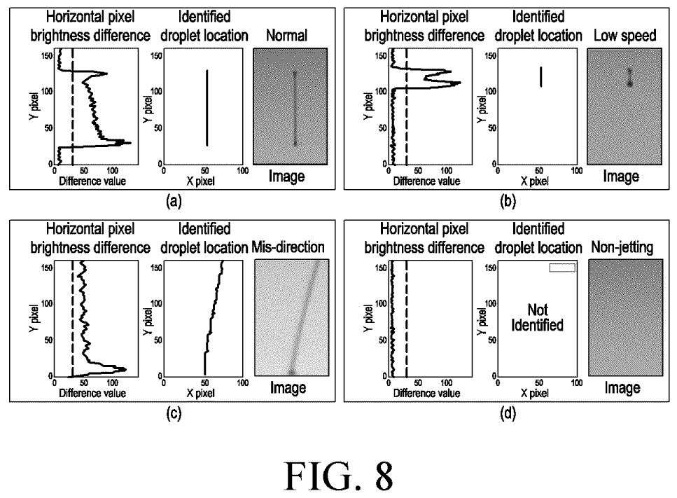

FIG. 7 illustrates an embodiment of software 710 and hardware 720 for vision analysis according to the disclosure. FIG. 8 illustrates an embodiment of vision analysis results for various jetting states according to the disclosure.

Referring to FIGS. 7 and 8, the monitoring system (e.g., the inkjet head monitoring system 100) in an embodiment may perform vision analysis to statistically identify the jetting state of a nozzle according to a self-sensing signal. The inkjet head monitoring system (also referred to as a monitoring system) 100 in an embodiment may be provided with hardware 720 including the head 110 with 1024 nozzles in 8 nozzle rows, the strobe light-emitting diode (LED) 170, and the camera 180, and software 710 (e.g., a program) that obtains a vision analysis result by sequentially scanning the 1024 nozzles in the 8 nozzle rows of the head 110.

In an embodiment, the monitoring system 100 may obtain a data set by performing scanning for the self-sensing signals of nozzles and performing scanning according to vision analysis of droplets sprayed from the nozzles.

In an embodiment, the monitoring system 100 may automatically classify jetting states by identifying as the results of scanning according to vision analysis, the positions, speeds (according to position changes), jetting or non-jetting, and directionality of the droplets.

In an embodiment, (a) of FIG. 8 illustrates vision analysis results for a normal jetting state of a nozzle. In an embodiment, (b) of FIG. 8 illustrates vision analysis results for an abnormal state where the jetting speed of the nozzle is bad. In an embodiment, (c) of FIG. 8 illustrates vision analysis results for an abnormal state where the spraying directionality of the nozzle is bad. (d) of FIG. 8 illustrates vision analysis results for an abnormal state caused by non-jetting of the nozzle.

In an embodiment, the monitoring system 100 may obtain a self-sensing signal for each nozzle, classify a jetting state according to vision analysis, and set a threshold for determining a jetting state through statistical analysis of the self-sensing signal.

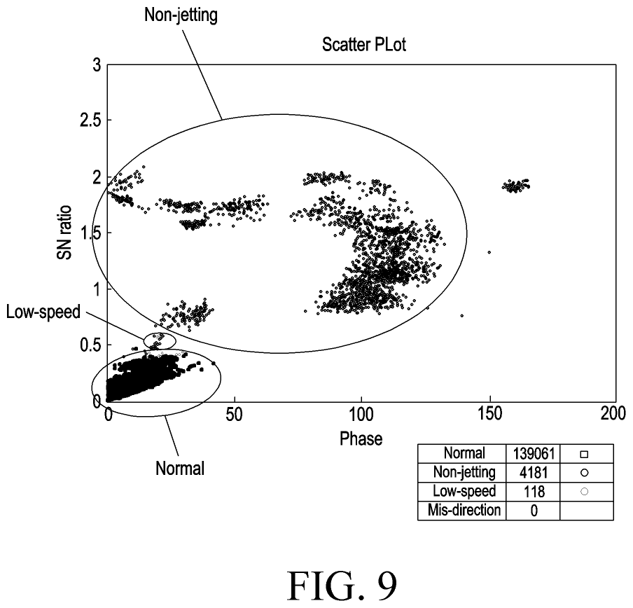

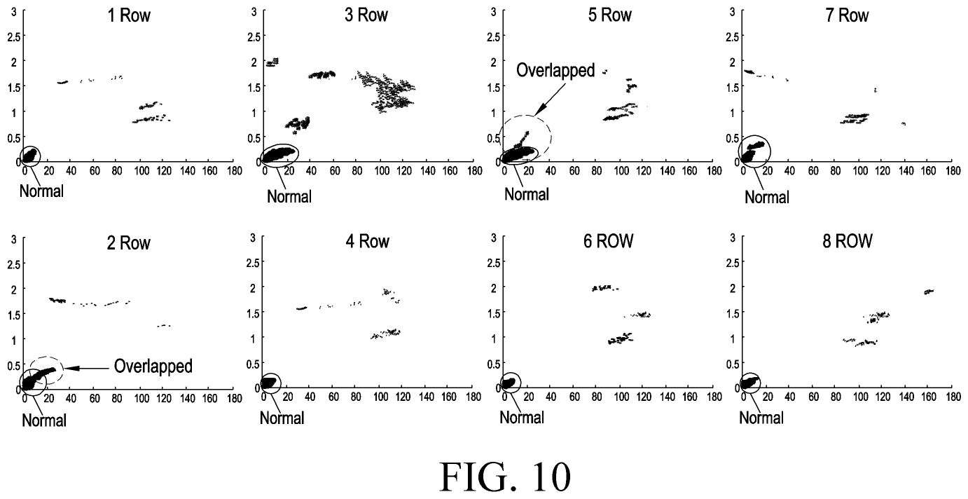

FIG. 9 is a scatter plot illustrating an embodiment of differences in amplitude and phase between self-sensing signals and reference signals in entire nozzles according to the disclosure. FIG. 10 is a scatter plot illustrating an embodiment of differences in amplitude and phase between self-sensing signals and a reference signal in each nozzle row according to the disclosure. For the scatter plots, operating states are classified through vision image analysis, and according to the vision analysis, they may be classified as jetting, non-jetting, or poor jetting speed, which may be displayed as a scatter plot for the phase and amplitude differences of self-sensing signals.

Referring to FIGS. 9 and 10, the scatter plots in an embodiment set a phase difference between a self-sensing signal and a reference signal of a nozzle on the X axis, and an amplitude difference between the self-sensing signal and the reference signal on the Y axis. In an embodiment, the phase difference may be a phase difference of the self-sensing signal corresponding to the center frequency of the self-sensing signal, and may be the result of [Equation 6]. In an embodiment, the amplitude difference may be the difference between the amplitude of the self-sensing signal corresponding to the center frequency and an adjacent frequency of the self-sensing signal, and may be the result of [Equation 5].

In an embodiment, FIGS. 9 and 10 are scatter plots illustrating points based on results (phases) of [Equation 6] on the X axis and results (SN ratios) of [Equation 5] on the Y axis, and each point is illustrated in a color according to the jetting state of a nozzle classified based on the vision analysis result.

In an embodiment, the processor 140 may set a first threshold and a second threshold for an amplitude difference and a phase difference, respectively, based on statistical analysis according to a scatter plot. In an embodiment, since points corresponding to nozzles in the normal state are disposed at a phase difference of 40 degrees or less and an amplitude difference of 0.4 or less according to the obtained scatter plot, e.g., the processor 140 may set the first threshold to 40 degrees and the second threshold to 0.4.

In an embodiment, the processor 140 may set the first threshold and the second threshold to smaller values in order to reduce uncertainty. In this case, however, the number of nozzles monitored as normal may be reduced, and a path for printing may be expanded. In an embodiment, although the processor 140 may set the first threshold and the second threshold to larger values, the possibility of determining abnormal nozzles as normal may increase in this case.

In an embodiment, as points in the normal state and points in the abnormal state may overlap in some nozzle rows (e.g., 2 row and 5 row), it may be difficult to set the first threshold and the second threshold. This problem may be related to the noise levels of the drivers 130 and the circuits.

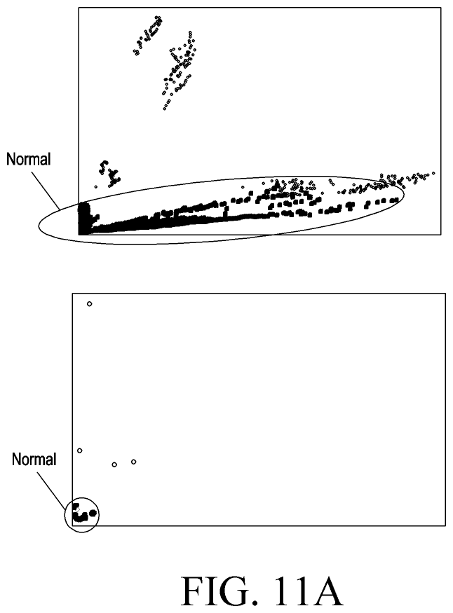

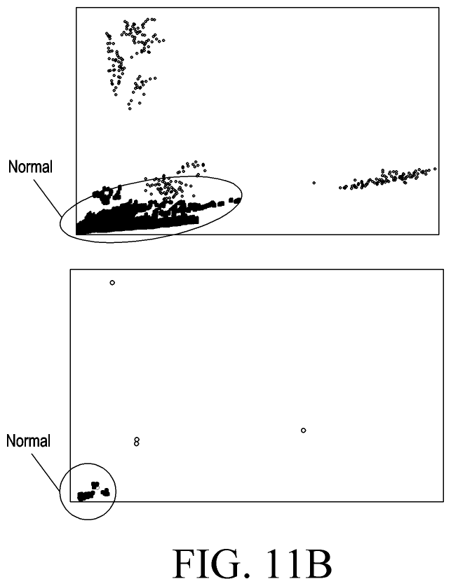

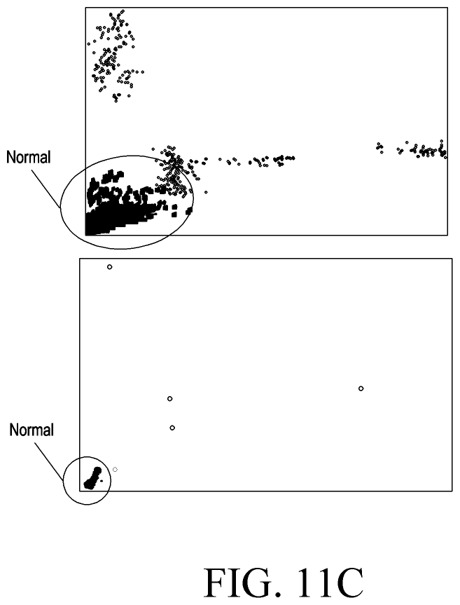

FIG. 11A is an embodiment of a scatter plot illustrating the differences in amplitude and phase between self-sensing signals and reference signals before noise cancellation according to the disclosure. FIG. 11B is a scatter plot illustrating an embodiment of the differences in amplitude and phase between self-sensing signals with driving noise canceled therefrom and reference signals according to the disclosure. FIG. 11C is an embodiment of a scatter plot illustrating the differences in amplitude and phase between self-sensing signals and reference signals, corresponding to the center frequencies of the self-sensing signals according to the disclosure.

Referring to FIG. 11A, it may be identified that before noise cancellation, points corresponding to nozzles in the normal state are densely clustered in sections of relatively small amplitude differences, but phase differences are distributed in various ways. In other words, it may be identified that before noise cancellation, it is difficult to monitor nozzles based on phase differences.

Referring to FIG. 11B, it may be identified that points corresponding to the nozzles in the normal state are distributed in sections of relatively small amplitude and phase differences by cancelling driving noise. In other words, it may be identified that noise cancellation facilitates nozzle monitoring based on phase differences.

Referring to FIG. 11C, it may be identified that nozzles in the normal state are densely clustered in a smaller section by self-sensing signals and reference signals corresponding to center frequencies, according to frequency analysis of the self-sensing signals and the reference signals. In other words, applying a spectrum based on frequency analysis may facilitate monitoring the states of nozzles.

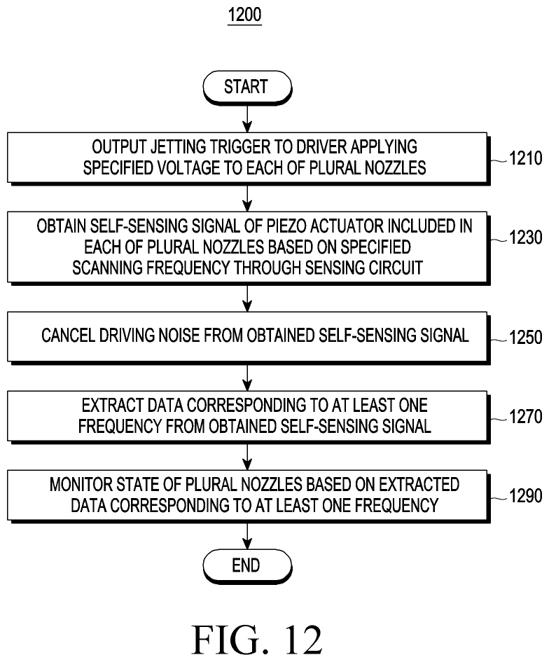

FIG. 12 is a flowchart 1200 illustrating an embodiment of a method of monitoring an inkjet head according to the disclosure.

Referring to FIG. 12, an inkjet head monitoring system (e.g., the inkjet head monitoring system 100 or the processor 140 of FIG. 1) in an embodiment may output a jetting trigger to a driver 130 that applies a specified voltage to each of a plurality of nozzles each including a piezo actuator and a switching element, in operation 1210.

The inkjet head monitoring system (e.g., the inkjet head monitoring system 100 or the processor 140 of FIG. 1) in an embodiment may obtain a self-sensing signal of the piezo actuators included in the plurality of nozzles based on a specified scanning frequency through a sensing circuit 160 in operation 1230.

The inkjet head monitoring system (e.g., the inkjet head monitoring system 100 or the processor 140 of FIG. 1) in an embodiment may further include an operation of cancelling driving noise from the obtained self-sensing signal in operation 1250.

In an embodiment, the driving noise may be a sensing signal obtained through the sensing circuit 160, while a specified voltage is applied to the plurality of nozzles by the driver 130 and all of the plurality of nozzles are turned off.

The inkjet head monitoring system (e.g., the inkjet head monitoring system 100 or the processor 140 of FIG. 1) in an embodiment may extract data corresponding to at least one frequency from the obtained self-sensing signal in operation 1270.

The inkjet head monitoring system (e.g., the inkjet head monitoring system 100 or the processor 140 of FIG. 1) in an embodiment may extract an amplitude or a phase of the self-sensing signal corresponding to the at least one frequency based on FFT analysis.

The inkjet head monitoring system (e.g., the inkjet head monitoring system 100 or the processor 140 of FIG. 1) in an embodiment may extract amplitudes of the self-sensing signal corresponding to a plurality of frequencies including a center frequency of the self-sensing signal.

In an embodiment, the processor 140 may normalize the difference between an amplitude of the self-sensing signal corresponding to the at least one frequency and an amplitude of a specified reference signal corresponding to the at least one frequency by dividing the difference by the amount of variation of noise.

The inkjet head monitoring system (e.g., the inkjet head monitoring system 100 or the processor 140 of FIG. 1) in an embodiment may extract a difference between a phase of the self-sensing signal corresponding to the center frequency of the self-sensing signal and a phase of the specified reference signal corresponding to the center frequency of the self-sensing signal.

The inkjet head monitoring system (e.g., the inkjet head monitoring system 100 or the processor 140 of FIG. 1) in an embodiment may monitor states of the plurality of nozzles based on the extracted data corresponding to the at least one frequency in operation 1290.

The inkjet head monitoring system (e.g., the inkjet head monitoring system 100 or the processor 140 of FIG. 1) in an embodiment may monitor the states of the plurality of nozzles by comparing differences between amplitudes and phases of the self-sensing signal corresponding to the at least one frequency and the specified reference signal corresponding to the at least one frequency with a first threshold and a second threshold.

The inkjet head monitoring system (e.g., the inkjet head monitoring system 100 or the processor 140 of FIG. 1) in an embodiment may obtain the first threshold for an amplitude difference and the second threshold for a phase difference, respectively, based on statistical analysis related to the differences between the amplitudes and phases of the self-sensing signal corresponding to the at least one frequency and the specified reference signal corresponding to the at least one frequency.

According to the monitoring system (e.g., the inkjet head monitoring system 100) and method in an embodiment, a threshold for determining the normal state of a nozzle may be appropriately set. In an embodiment, when the threshold is set too small, the number of nozzles determined as normal decreases, and thus a printing path (swath) may increase, whereas when the threshold is set too large, even defective nozzles may be determined as normal, for example.

According to the monitoring system 100 and method in an embodiment, a parameter for distinguishing between the normal and abnormal states of nozzles based on the design of the sensing circuit 160 and/or the driver 130 may be obtained.

According to the monitoring system 100 and method in an embodiment, the reliability of a printing operation may be increased by excluding an abnormal nozzle from printing among a plurality of nozzles.

An inkjet printing system in an embodiment may use a method of restoring the state of a nozzle by a purge that pushes out ink with pressure so that the ink is sprayed into the nozzle, when a discharge failure occurs in the nozzle. The monitoring system 100 and method in an embodiment may enable nozzle maintenance, while consuming minimal ink, by performing a purge operation on a nozzle based on a monitoring result and determining whether the nozzle is restored through the purge.

In the inkjet printing system in an embodiment, although ink should be supplied evenly to fine nozzle paths at the beginning when ink is injected into the head 110, air bubbles may be generated and thus even when a purge operation is performed, air bubbles may exist in a predetermined nozzle. The monitoring system 100 and method in an embodiment may reduce an unnecessary ink purge operation and ink consumption by monitoring a process of injecting ink into the head 110.

According to the monitoring system 100 and method in an embodiment, an entirety of the inkjet printing operation including ink injection, maintenance, monitoring of nozzle state, and printing excluding defective nozzles may be automated by a software algorithm without a separate manipulation. In an embodiment, a database may be secured by artificial intelligence, and secured data may be used to improve the algorithm by deep learning or machine learning.

The inkjet head monitoring system 100 in an embodiment of the disclosure may include the head 110 having a plurality of nozzles each including a piezo actuator and a switching element, the driver 130 applying a specified voltage to the plurality of nozzles, the sensing circuit 160 obtaining a self-sensing signal from the piezo actuator, and the at least one processor 140. The at least one processor 140 may output a jetting trigger to the driver 130 to apply a voltage to the plurality of nozzles. The at least one processor 140 may obtain the self-sensing signal from the piezo actuators included in the plurality of nozzles based on a specified scanning frequency through the sensing circuit 160. The at least one processor 140 may extract data corresponding to at least one frequency through the obtained self-sensing signal. The at least one processor 140 may monitor a state of the plurality of nozzles, based on the extracted data corresponding to the at least one frequency.

In the inkjet head monitoring system 100 in an embodiment, the at least one processor 140 may extract an amplitude or a phase of the self-sensing signal corresponding to the at least one frequency based on discrete FFT analysis, as at least a part of extracting the data corresponding to the at least one frequency.

In the inkjet head monitoring system 100 in an embodiment, the at least one processor 140 may extract amplitudes of the self-sensing signal corresponding to a plurality of frequencies including a center frequency of the self-sensing signal, as at least a part of extracting the data corresponding to the at least one frequency.

In the inkjet head monitoring system 100 in an embodiment, the at least one processor 140 may divide a difference between the amplitude of the self-sensing signal corresponding to the at least one frequency and an amplitude of a specified reference signal corresponding to the at least one frequency by an amount of variation of noise, as at least a part of extracting the data corresponding to the at least one frequency.

In the inkjet head monitoring system 100 in an embodiment, the at least one processor 140 may extract a difference between a phase of the self-sensing signal corresponding to the center frequency of the self-sensing signal and a phase of the specified reference signal corresponding to the center frequency of the self-sensing signal, as at least a part of extracting the data corresponding to the at least one frequency.

In the inkjet head monitoring system 100 in an embodiment, the at least one processor 140 may be configured to, based on statistical analysis related to an amplitude difference and a phase difference between the self-sensing signal corresponding to the at least one frequency and the specified reference signal corresponding to the at least one frequency, obtain a first threshold for the amplitude difference and a second threshold for the phase difference, respectively, as at least a part of monitoring the state of the plurality of nozzles.

In the inkjet head monitoring system 100 in an embodiment, the at least one processor 140 may cancel driving noise obtained through the sensing circuit 160 from the obtained self-sensing signal, while the plurality of nozzles are all turned off by applying the specified voltage to the plurality of nozzles.

In the inkjet head monitoring system 100 in an embodiment, the plurality of nozzles may be divided into a nozzle row having a plurality of nozzles arranged on the same line, and an electrically independent nozzle module including at least one nozzle row.

A method of monitoring the inkjet head 110 in an embodiment of the disclosure may include outputting (operation 1210) a jetting trigger to the driver 130 applying a specified voltage to each of a plurality of nozzles each including a piezo actuator and a switching element. The method of monitoring the inkjet head 110 in an embodiment of the disclosure may include obtaining (operation 1230) a self-sensing signal from the piezo actuators included in the plurality of nozzles based on a specified scanning frequency through the sensing circuit 160. The method of monitoring the inkjet head 110 in an embodiment of the disclosure may include extracting (operation 1270) data corresponding to at least one frequency through the obtained self-sensing signal. The method of monitoring the inkjet head 110 in an embodiment of the disclosure may include monitoring (operation 1290) a state of the plurality of nozzles, based on the extracted data corresponding to the at least one frequency.

In the method of monitoring the inkjet head 110 according to the disclosure, extracting (operation 1270) the data corresponding to the at least one frequency may include extracting an amplitude or a phase of the self-sensing signal corresponding to the at least one frequency based on discrete FFT analysis.

In the method of monitoring the inkjet head 110 according to the disclosure, extracting (operation 1270) the data corresponding to the at least one frequency may include extracting amplitudes of the self-sensing signal corresponding to a plurality of frequencies including a center frequency of the self-sensing signal.

In the method of monitoring the inkjet head 110 according to the disclosure, extracting (operation 1270) the data corresponding to the at least one frequency may include dividing a difference between the amplitude of the self-sensing signal corresponding to the at least one frequency and an amplitude of a specified reference signal corresponding to the at least one frequency by an amount of variation of noise.

In the method of monitoring the inkjet head 110 according to the disclosure, extracting (operation 1270) the data corresponding to the at least one frequency may include extracting a difference between a phase of the self-sensing signal corresponding to the center frequency of the self-sensing signal and a phase of the specified reference signal corresponding to the center frequency of the self-sensing signal.

In the method of monitoring the inkjet head 110 according to the disclosure, monitoring (operation 1290) the state of the plurality of nozzles may include, based on statistical analysis related to an amplitude difference and a phase difference between the self-sensing signal corresponding to the at least one frequency and the specified reference signal corresponding to the at least one frequency, obtaining a first threshold for the amplitude difference and a second threshold for the phase difference, respectively.

The method of monitoring the inkjet head 110 in an embodiment of the disclosure may further include canceling (operation 1250) driving noise obtained through the sensing circuit 160 from the obtained self-sensing signal, while the plurality of nozzles are all turned off by applying the specified voltage to the plurality of nozzles.

A non-transitory computer-readable storage medium storing at least one program in an embodiment of the disclosure may include, based on execution of an application, outputting a jetting trigger to the driver 130 applying a specified voltage to each of a plurality of nozzles each including a piezo actuator and a switching element. The storage medium in an embodiment of the disclosure may include obtaining a self-sensing signal from the piezo actuators included in the plurality of nozzles based on a specified scanning frequency through the sensing circuit 160. The storage medium in an embodiment of the disclosure may include extracting data corresponding to at least one frequency through the obtained self-sensing signal. The storage medium in an embodiment of the disclosure may include monitoring a state of the plurality of nozzles, based on the extracted data corresponding to the at least one frequency.

The inkjet head monitoring system 100 in an embodiment of the disclosure may include the head 110 having a plurality of nozzles each including a piezo actuator and a switching element, the driver 130 applying a specified voltage to the plurality of nozzles, the sensing circuit 160 obtaining a self-sensing signal from the piezo actuator, and the at least one processor 140. The at least one processor 140 may output a jetting trigger to the driver 130 to apply a voltage to the plurality of nozzles. The at least one processor 140 may obtain the self-sensing signal from the piezo actuators included in the plurality of nozzles based on a specified scanning frequency through the sensing circuit 160. The at least one processor 140 may monitor a state of the plurality of nozzles, based on an amplitude difference or a phase difference between the obtained self-sensing signal and a specified reference signal.

In the inkjet head monitoring system 100 in an embodiment, the at least one processor 140 may cancel driving noise obtained through the sensing circuit 160 from the obtained self-sensing signal, while the plurality of nozzles are all turned off by applying the specified voltage to the plurality of nozzles.

In the inkjet head monitoring system 100 in an embodiment, the at least one processor 140 may extract data corresponding to at least one frequency from the obtained self-sensing signal.

In the inkjet head monitoring system 100 in an embodiment, the at least one processor 140 may extract an amplitude or a phase of the self-sensing signal corresponding to the at least one frequency based on discrete FFT analysis, as at least a part of extracting the data corresponding to the at least one frequency.

In the inkjet head monitoring system 100 in an embodiment, the at least one processor 140 may be configured to, based on statistical analysis related to an amplitude difference and a phase difference between the obtained self-sensing signal and the specified reference signal, obtain a first threshold for the amplitude difference and a second threshold for the phase difference, respectively, as at least a part of monitoring the state of the plurality of nozzles.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Embodiments of the disclosure may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An inkjet head monitoring system comprising:
a head equipped with a plurality of nozzles respectively including piezo actuators and switching elements;
a driver configured to apply a specified voltage to the plurality of nozzles;
a sensing circuit configured to obtain a self-sensing signal from the piezo actuators;
memory storing instructions; and
at least one processor
wherein the instructions, when executed by the processor individually or collectively, cause the inkjet head monitoring system to:
output a jetting trigger to the driver to apply a voltage to the plurality of nozzles,
obtain the self-sensing signal from the piezo actuators respectively included in the plurality of nozzles based on a specified scanning frequency through the sensing circuit,
extract data corresponding to at least one frequency through the obtained self-sensing signal, and
monitor a state of the plurality of nozzles, based on the extracted data corresponding to the at least one frequency.

2. The inkjet head monitoring system of claim 1, wherein the at least one processor is configured to extract an amplitude or a phase of the self-sensing signal corresponding to the at least one frequency based on discrete fast Fourier transform analysis, as at least a part of extracting the data corresponding to the at least one frequency.

3. The inkjet head monitoring system of claim 2, wherein the at least one processor is configured to extract amplitudes of the self-sensing signal corresponding to a plurality of frequencies including a center frequency of the self-sensing signal, as at least a part of extracting the data corresponding to the at least one frequency.

4. The inkjet head monitoring system of claim 2, wherein the at least one processor is configured to divide a difference between the amplitude of the self-sensing signal corresponding to the at least one frequency and an amplitude of a specified reference signal corresponding to the at least one frequency by an amount of variation of noise, as at least a part of extracting the data corresponding to the at least one frequency.

5. The inkjet head monitoring system of claim 4, wherein the at least one processor is configured to extract a difference between a phase of the self-sensing signal corresponding to a center frequency of the self-sensing signal and a phase of a specified reference signal corresponding to the center frequency of the self-sensing signal, as at least a part of extracting the data corresponding to the at least one frequency.

6. The inkjet head monitoring system of claim 4, wherein the at least one processor is configured to, based on statistical analysis related to an amplitude difference and a phase difference between the self-sensing signal corresponding to the at least one frequency and a specified reference signal corresponding to the at least one frequency, obtain a first threshold for the amplitude difference and a second threshold for the phase difference, respectively, as at least a part of monitoring the state of the plurality of nozzles.

7. The inkjet head monitoring system of claim 1, wherein the at least one processor is configured to cancel driving noise obtained through the sensing circuit from the obtained self-sensing signal, while the plurality of nozzles are all turned off by applying the specified voltage to the plurality of nozzles.

8. The inkjet head monitoring system of claim 1, wherein the plurality of nozzles are divided into a nozzle row having nozzles, the plurality of nozzles arranged on the same line, and an electrically independent nozzle module including at least one nozzle row.

9. A method of monitoring an inkjet head, the method comprising:
outputting a jetting trigger to a driver configured to apply a specified voltage to each of a plurality of nozzles respectively including piezo actuators and switching elements;
obtaining a self-sensing signal from the piezo actuators included in the plurality of nozzles based on a specified scanning frequency through a sensing circuit;
extracting data corresponding to at least one frequency through the obtained self-sensing signal; and
monitoring a state of the plurality of nozzles, based on the extracted data corresponding to the at least one frequency.

10. The method of claim 9, wherein extracting the data corresponding to the at least one frequency includes extracting an amplitude or a phase of the self-sensing signal corresponding to the at least one frequency based on discrete fast Fourier transform analysis.

11. The method of claim 10, wherein extracting the data corresponding to the at least one frequency includes extracting amplitudes of the self-sensing signal corresponding to a plurality of frequencies including a center frequency of the self-sensing signal.

12. The method of claim 10, wherein extracting the data corresponding to the at least one frequency includes dividing a difference between the amplitude of the self-sensing signal corresponding to the at least one frequency and an amplitude of a specified reference signal corresponding to the at least one frequency by an amount of variation of noise.

13. The method of claim 12, wherein extracting the data corresponding to the at least one frequency includes extracting a difference between a phase of the self-sensing signal corresponding to a center frequency of the self-sensing signal and a phase of a specified reference signal corresponding to the center frequency of the self-sensing signal.

14. The method of claim 12, wherein monitoring the state of the plurality of nozzles includes, based on statistical analysis related to an amplitude difference and a phase difference between the self-sensing signal corresponding to the at least one frequency and a specified reference signal corresponding to the at least one frequency, obtaining a first threshold for the amplitude difference and a second threshold for the phase difference, respectively.

15. The method of claim 9, further comprising canceling driving noise obtained through the sensing circuit from the obtained self-sensing signal, while the plurality of nozzles are all turned off by applying the specified voltage to the plurality of nozzles.

16. The method of claim 9, wherein the plurality of nozzles are divided into a nozzle row having nozzles, the plurality of nozzles, arranged on the same line, and an electrically independent nozzle module including at least one nozzle row.

17. One or more non-transitory computer-readable storage media storing one or more computer programs including computer-executable instructions that, when executed by at least one processor, cause an inkjet head monitoring system to perform operations, the operations comprising:
output a jetting trigger to a driver configured to apply a specified voltage to each of a plurality of nozzles respectively including piezo actuators and switching elements;
obtain a self-sensing signal from the piezo actuators included in the plurality of nozzles based on a specified scanning frequency through a sensing circuit;
extract data corresponding to at least one frequency through the obtained self-sensing signal; and
monitor a state of the plurality of nozzles, based on the extracted data corresponding to the at least one frequency.
